(19) United States
(12) Patent Application Publication
(10) Pub. No.: US 2001/0029736 A1
(43) Pub. Date: Oct. 18, 2001

(54) Control device for a cylinder, a method of controlling a cylinder, a control unit as well as an agricultural machine provided with said device and an agricultural machine provided with said control unit

(75) Inventor: Cornelis Franciscus Johannes Geerts, Moergestel (NL)

Correspondence Address: Penrose Lucas Albright, Esq., MASON, MASON & ALBRIGHT, P.O. Box 2246, Arlington, VA, 22202-0246, US

(73) Assignee: LELY RESEARCH HOLDING A.G. A SWISS LIMITED LIABILITY COMPANY

(21) Appl. No.: 09/832,118

(22) Filed: Apr. 11, 2001

(30) Foreign Application Priority Data
Apr. 11, 2000 (NL) 1014903

(51) Int. Cl. F15B 7/00; B60T 13/58

(52) U.S. Cl. 60/563; 60/533

(57) ABSTRACT

A control device for a cylinder (1) is provided with an entrance (4) which is connectable to a pressure source and with an exit (5) which is connectable to the cylinder (1) that is controllable by means of the pressure source. The device (2) comprises means (6 to 12) for defining an intermediate position, not being one of the end positions, in the stroke of the cylinder piston (3). Thus a large number of options for use and application possibilities for the cylinder (1) can be realized in a simple, compact and cheap manner.

The invention relates to a device as described in the preamble of claim 1. The invention further relates to a method of controlling a cylinder by means of said device, a control unit provided with two devices, and an agricultural machine provided with said device or said control unit.

The invention aims at further developing and improving such a hydraulic or pneumatic control device. According to the invention this is achieved by the measures indicated in the characterizing part of claim 1. The control device is connected between the pressure source and the cylinder to be controlled and defines an intermediate position in the stroke of the cylinder piston, without further external mechanical or electronic components being used. This makes it possible to realize in a simple and cheap manner a large number of options for use and application possibilities for the cylinder. The device is further very compact.

The invention will now be explained in further detail with reference to the accompanying figures.

FIG. 1 is a schematic view of a cylinder with a device according to the invention;

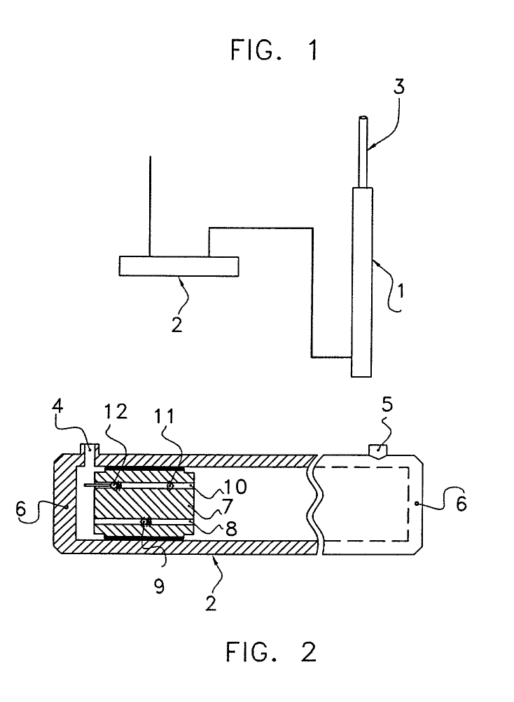

FIG. 2 shows schematically a partial cross-section of said device;

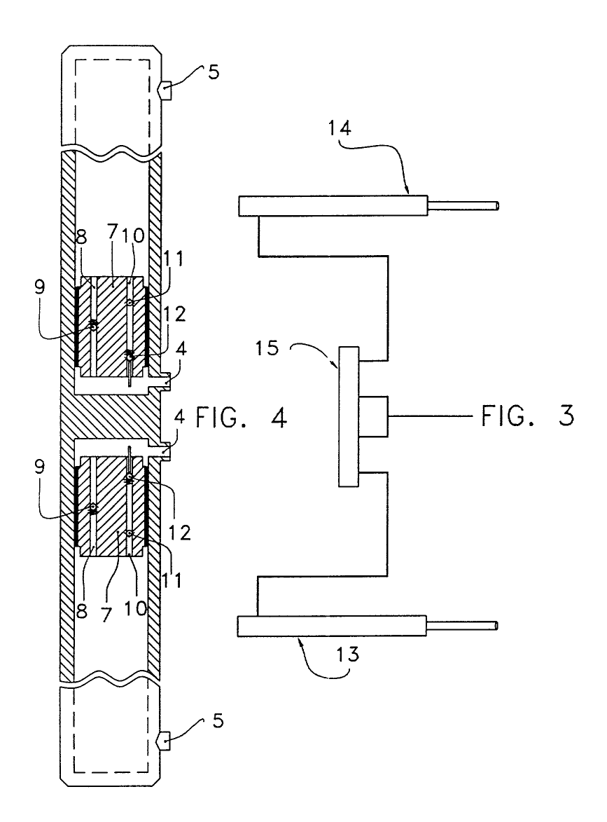

FIG. 3 is a schematic view of two cylinders with a control unit according to the invention, and

FIG. 4 shows schematically a partial cross-section of the control unit.

FIG. 1 shows schematically a cylinder 1 with a control device 2 according to the invention. For the sake of simplicity, the device 2 will be described hereinafter as a hydraulic one, but, of course, differently designed devices, such as e.g. a pneumatic one, are possible as well. The device 2 has a hydraulic entrance (in FIG. 1 on the left) which is connectable to a non-shown pressure source, known per se, for example that of a tractor. The device 2 further has an exit which is connectable to the hydraulic cylinder 1 that is controllable by means of the pressure source.

According to the invention the device 2 is provided with means for defining an intermediate position, not being one of the end positions, in the stroke of the cylinder piston 3. Said means are illustrated in FIG. 2 in which a partial cross-section of the device 2 is shown schematically. The device 2 with the entrance 4 and the exit 5 comprises a housing 6 in which a piston 7 is movable between a first and a second end point (on the left, respectively on the right). The first end point is hydraulically connectable to the pressure source via the entrance 4 and the second end point is hydraulically connectable to an end of the cylinder 1 via the exit 5. The stroke volume of the piston 7 is smaller than that of the cylinder piston 3. As a result thereof the cylinder piston 3 does not make a complete stroke when the piston 7 makes a complete stroke (from the first to the second end point).

The piston 7 is provided with a first hydraulic conduit 8 with a first valve 9 having an opening pressure of e.g. 50 bar, so that, at a pressure difference between the first and the second end point which is greater than the opening pressure, the first conduit 8 is open in the direction from the first to the second end point. When in another embodiment the opening pressure has the value zero, the valve 9 will open immediately at an overpressure on the side of the first end point (in FIG. 2 on the left).

Furthermore, the piston 7 has a second hydraulic conduit 10 with a second valve 11 (constituted by a non-return valve), so that the second conduit 10 is always closed in the direction from the first to the second end point. In the second conduit 10 there is further provided a third valve 12 which is designed as a controllable one, so that, when the piston 7 is located at the first end point, the second conduit 10 is open in the direction from the second to the first end point. The fact is that, as soon as the piston 7 in FIG. 2 on the left reaches the first end point, the controllable valve 12 will open, so that the second conduit 10 with the valve 11 will open in the direction from the right to the left in FIG. 2.

The device 2 functions as follows. In the starting position the piston 7 is located at the first end point (in the figure on the left) and the cylinder piston 3 is in its lowest end position (completely retracted). On activating the pressure source (which then produces a pressure of e.g. 80 bar via the entrance 4) the piston 7 is moved from the first end point to the second end point, while oil is pressed to the cylinder 1 via the exit 5, so that the cylinder piston 3 is extended. When the piston 7 reaches the second end point, the cylinder piston 3 has only performed a part of its complete stroke. The pressure source will now further increase the pressure to e.g. 130 bar, so that the valve 9 will open the first conduit 8. The oil can then flow on to the cylinder 1 and further extend the cylinder piston 3 into its upper (completely extended) end position. The cylinder piston 3 will then move more slowly than before, because the diameter of the conduit 8 is smaller than that of the exit 5 of the device 2. So, exactly at the point of time when the piston 7 reaches the second end point, there occurs a speed change with the cylinder piston 3. This speed change can clearly be established, so that in this manner an intermediate position in the stroke of the cylinder piston 3 is defined.

If necessary or desirable, on establishing the change of speed, a user can stop the cylinder piston 3 in its intermediate position by keeping the pressure produced by the pressure source further at a constant level.

Besides, by choosing a very high opening pressure for the valve 9 it can be achieved that the conduit 8 remains always closed in practice. In that case the cylinder piston 3 will not extend further when the piston 7 reaches the second end point. The stroke of the cylinder piston 3 is then reduced to as far as the intermediate position.

On retracting the cylinder piston 3 by deactivating the pressure source, the piston 7 is moved first from the second end point to the first end point. As soon as the piston 7 reaches the second end point, the conduit 10 will open with the aid of the valve 12. Then the cylinder piston 3 can possibly further slide inwards until it reaches its end position.

The conduits 8, 10 may be provided with a constriction or throttle to ensure that the change of speed can clearly be established. Furthermore, the device 2 may also be provided with non-shown means for setting the intermediate position. Said means may for example be designed such that they adjustably reduce the stroke of the piston 7 in the housing 6.

With an agricultural machine (for example a haymaking machine such as a raking machine or a tedder) a device 2 can be used for lifting crop working members to a certain extent, for example at the headland, without the need of lifting them into the very transport position. Generally speaking, the device can be used with machines of which certain elements or members are brought from an operative position into a transport position via a (passive) intermediate position and vice versa.

FIG. 3 shows schematically two cylinders 13, 14 with a control unit 15 according to the invention. FIG. 4 shows schematically a partial cross-section of said control unit 15 which is essentially a double realization of the control device 2 according to FIG. 2 and functions analogously. In one housing two devices according to FIG. 2 are integrated. The two devices have substantially equal dimensions.

The entrances of the control unit 15 are both connectable to the pressure source and the exits of the control unit 15 are each connectable to a cylinder 13 respectively 14, each of which is controllable by means of the pressure source.

The control unit 15 has the particular characteristic of actuating the two cylinders 13, 14 in such a manner that their cylinder pistons both (not necessarily at the same time) reach the intermediate position before moving further together. The fact is that when, due to a load difference of the two cylinders 13, 14, one of them will at first move faster than the other, the associated piston (7 in FIG. 2) will earlier reach the second end point. However, the pressure source now continues to generate the same pressure until the other piston 7 has reached the second end point as well. Only then the pressure source increases the pressure in the system, so that the valves 9 will open and the cylinder pistons will both be able to continue to move (more slowly).

The control unit 15 may be applied for example with an agricultural machine (such as a raking machine or a tedder) in which members are brought from an operative position via a (passive) intermediate position into a transport position and vice versa. By means of the control unit 15 two cylinders 13, 14 can be stopped in a particular fixed intermediate position. The location of the intermediate position may again be adjustable.

1. A control device for a cylinder, which device (2) is provided with an entrance (4) which is connectable to a pressure source, e.g. that of a tractor, and with an exit (5) which is connectable to the cylinder (1) that is controllable by means of the pressure source, characterized in that the device (2) comprises means (6 to 12) for defining an intermediate position, not being one of the end positions, in the stroke of the cylinder piston (3).

2. A device as claimed in claim 1, characterized in that the device comprises a housing (6) in which a piston (7) is movable between a first and a second end point, said first end point being connectable to the pressure source via the entrance (4) and said second end point being connectable to an end of the cylinder (1) via the exit (5).

3. A device as claimed in claim 2, characterized in that the stroke volume of the piston (7) is smaller than that of the cylinder piston (3).

4. A device as claimed in claim 2 or 3, characterized in that the piston (7) is provided with a first conduit (8) with a first valve (9) having such an opening pressure that, at a pressure difference between the first and the second end point which is greater than the opening pressure, the first conduit (8) is open in the direction from the first to the second end point, and with a second conduit (10) with a second valve (11), so that the second conduit (10) is always closed in the direction from the first to the second end point, a third valve (12), which is designed as a controllable one, further being provided in the second conduit (10) so that, when the piston (7) is located at the first end point, the second conduit (10) is open in the direction from the second to the first end point.

5. A device as claimed in claim 4, characterized in that the diameter of the conduits (8, 10) is smaller than that of the exit (5) of the device (2).

6. A device as claimed in claim 4 or 5, characterized in that at least one of the conduits (8, 10) is provided with a throttle.

7. A device as claimed in any one of claims 1 to 6, characterized in that the device (2) is further provided with means for setting the intermediate position.

8. A method of controlling a cylinder by means of a pressure source and a device as claimed in any one of claims 1 to 7, characterized in that the following steps are taken:
activating the pressure source, so that the cylinder piston (3) will move;
establishing a speed change in the movement of the cylinder piston (3) as soon as the intermediate position has been reached;
if necessary, stopping the cylinder piston (3) by further keeping the pressure produced by the pressure source at a constant level.

9. A control unit provided with two devices as claimed in any one of claims 1 to 7, characterized in that the entrances of the devices are both connectable to the pressure source and the exits of the devices are each connectable to a cylinder (13, 14) that is controllable by means of the pressure source.

10. A control unit as claimed in claim 9, characterized in that said control unit is provided with a housing in which the two devices are integrated.

11. A control unit as claimed in claim 9 or 10, characterized in that the two devices have substantially equal dimensions.

12. An agricultural machine provided with a device (2) as claimed in any one of claims 1 to 7.

13. An agricultural machine provided with a control unit (15) as claimed in any one of claims 9 to 11.
